(19) United States
(12) Patent Application Publication
(10) Pub. No.: US 2011/0316913 A1
(43) Pub. Date: Dec. 29, 2011

(54) IMAGE FORMING APPARATUS

(75) Inventors: Satoshi Kaiho, Kanagawa-ken (JP); Nobuaki Takahashi, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/166,864

(22) Filed: Jun. 23, 2011

Related U.S. Application Data
(60) Provisional application No. 61/359,145, filed on Jun. 28, 2010.

(51) Int. Cl. B41J 2/01; B41J 29/38

(52) U.S. Cl. 347/9; 347/1; 347/5; 347/16

(57) ABSTRACT

According to one embodiment, an image forming apparatus includes a support table, a printing head, and a cleaner. The support table rotates around an axis. The printing head faces the support table. The cleaner includes a web coming into contact with the support table.

### CROSS-REFERENCE TO RELATED APPLICATIONS

This application is based upon and claims the benefit of priority from Provisional Application No. 61/359,145, filed on Jun. 28, 2010, the entire contents of which are incorporated herein by reference.

### FIELD

Embodiments described herein relate generally to an image forming apparatus that forms an image on a paper attracted onto a drum.

### BACKGROUND

From related art, there is an ink jet type image forming apparatus that has a paper transportation mechanism of an electrostatic attraction type. Such an image forming apparatus has a charging roller that charges a paper, and a drum that is rotated in a state in which the paper is attracted onto the surface thereof, as transportation mechanisms of the paper. There is a possibility of moisture attaching to the surface of the drum due to the skew of the paper, ink mist, printing outside of the paper, or the like. Then, since the attraction force of the paper declines, the drum cannot exactly transport the paper. Thus, the image forming apparatus has a blade made of rubber as a member that cleans the surface of the drum.

However, an edge of the blade may damage the drum such as cutting a coating on the surface of the drum. For this reason, the drum and the blade need to be exchanged as consumables. In addition, the damage to the surface of the drum mentioned as above may occur in an image forming apparatus other than an ink jet type.

### BRIEF DESCRIPTION OF THE DRAWINGS

FIG. 1 is a diagram that shows an outline of an image forming apparatus of an embodiment.

FIG. 2 is a block diagram that shows the image forming apparatus.

FIG. 3 is a flow chart of a printing process in the image forming apparatus.

### DETAILED DESCRIPTION

In general, according to one embodiment, an image forming apparatus includes a support table, a printing head, and a cleaner. The support table rotates around an axis. The printing head faces the support table. The cleaner includes a web coming into contact with the support table.

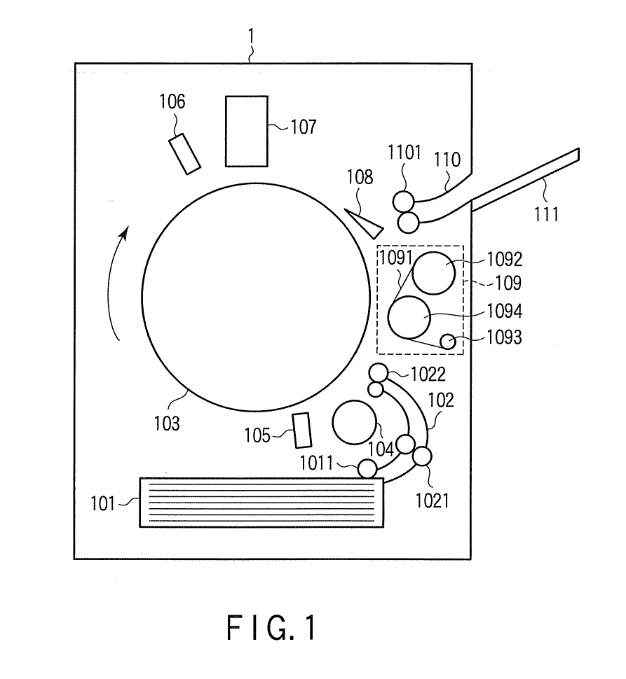

Hereinafter, the embodiment will be described with reference to the drawings. FIG. 1 is a diagram that shows an outline of an image forming apparatus 1 of the embodiment. The image forming apparatus 1 has a case 10, a paper cassette 101, a transport guide 102, a drum (support table) 103, a charging roller 104, a first sensor 105, a second sensor 106, an ink jet head (printing head) 107, a peeling claw 108, a cleaner 109, a transport guide 110, and a paper discharging tray 111. In addition, the support table 103 may be an endless belt without being limited to the drum.

The paper cassette 101 is disposed in a lower end in the case 10. The paper cassette 101 receives a paper bundle constituted by a plurality of papers. The paper cassette 101 has a pickup roller 1011 that comes into contact with the uppermost paper of the paper bundle. The transport guide 102 is disposed between positions where the paper cassette 101, the drum 103, and the charging roller 104 face each other. The transport guide 102 has a transport roller pair 1021, and a transport roller pair 1022.

The drum 103 can be rotated around the axis. In the embodiment, the drum 103 is rotated in an arrow direction shown in FIG. 1. The drum 103 is used to transport the paper that is attracted onto the surface in the circumferential direction by an electrostatic attraction manner. In the embodiment, the direction is defined as a transport direction of the paper. Furthermore, in the embodiment, the surface of the drum 103 refers to the surface in the circumferential direction of the drum 103. In the circumferential direction of the drum 103, a charging roller 104, a first sensor 105, a second sensor 106, an ink jet head 107, a peeling claw 108, and a cleaner 109 described below are sequentially disposed along the transport direction of the paper. The surface of the drum 103 is provided with a coating such as PTTE (polytetrafluoroethylene) on a base material of a conductor such as aluminum. The charging roller 104 is disposed near an outlet of the transport guide 102. The charging roller 104 can be rotated around the axis. In addition, the charging roller 104 is able to be moved to a position where the charging roller comes into contact with or is separated from the drum 103. The charging roller 104 is formed of a conductive sponge or the like.

The first sensor 105 is disposed to the downstream of the charging roller 104. The first sensor 105 detects that the paper exists in the detection region. The second sensor 106 is disposed to the downstream of the first sensor 105. The second sensor 106 detects that the paper is present in the detection region. The ink jet head 107 is disposed to the downstream of the second sensor 106. The ink jet head 107 has a plurality of nozzles in a main scanning direction perpendicular to the transport direction of the paper at a predetermined pitch. The ink jet head 107 is able to be moved in the main scanning direction. In addition, the image forming apparatus 1 may have a plurality of ink jet heads. The peeling claw 108 is disposed to the downstream of the ink jet head 107. The peeling claw 108 is movable so that an end thereof is used as a shaft. The tip of the peeling claw 108 is able to be moved to a position where the tip comes into contact with or is separated from the drum 103.

The cleaner 109 is disposed to the downstream of the peeling claw 108 and the upstream of the charging roller 102. The cleaner 109 has a web 1091, a first roller 1092, a second roller 1093, and a third roller 104. The web 1091 is a nonwoven fabric. The web 1091 has a width of the same size as the size of the drum 103 in the axial direction. The first roller 1092 is rotatable around the axis. The first roller 1092 supports an end in the longitudinal direction of the web 1091. The second roller 1093 is disposed to the downstream of the first roller 1092. The second roller 1093 supports the other end of the web 1091 in the longitudinal direction. Thus, the web 1091 is extended between the first roller 1092 and the second roller 1093. In an initial state, the web 1091 is wound around the second roller 1093. The third roller 1094 is disposed between the first roller 1092 and the second roller 1093. The third roller 1094 faces the drum 103 with the web 1091 interposed. The third roller 1094 has a width of the same size as the width of the web 1091. The third roller 1094 is rotatable around the axis. In addition, the third roller 1094 is movable to a position where the third roller 1094 comes into contact with or is separated from the drum 103. The third roller 1094 may have a member that holds the web 1091.

The transport guide 110 is disposed between the vicinity of the peeling claw 108 and the case 10. The transport guide 110 has a transport roller pair 1101. The paper discharging tray 111 is disposed outside the case 10. The paper discharging tray 111 sequentially accommodates the printed paper, which is transported via the transport guide 110, in a stacked state.

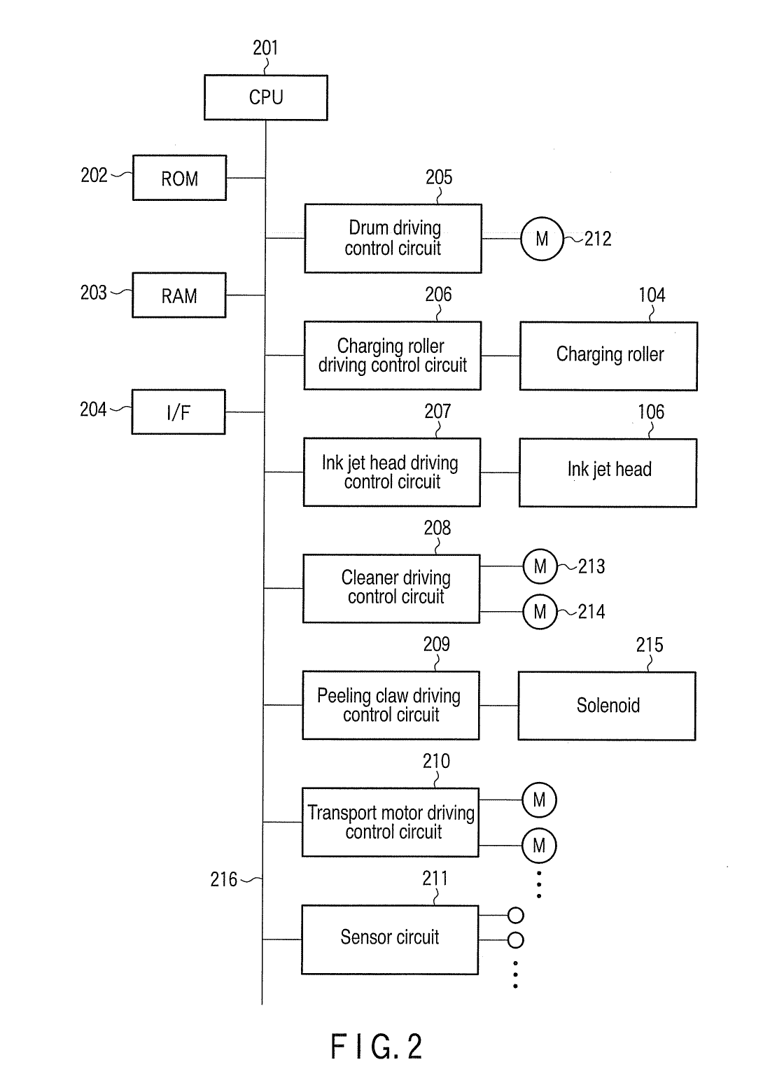

FIG. 2 is a block diagram that shows a control system of the image forming apparatus 1. The image forming apparatus 1 has a CPU (a controller) 201, a ROM 202, a RAM 203, an I/F 204, a drum driving control circuit 205, a charging roller driving control circuit 206, an ink jet head driving control circuit 207, a cleaner driving control circuit 208, a peeling claw driving control circuit 209, a transport motor driving control circuit 210, a sensor circuit 211 or the like.

The CPU 201 controls the operations of each portion connected via a CPU bus 216. The ROM 202 stores various programs that are executed by the CPU 201. The RAM 203 preserves various data. The I/F 204 connects an external computer to the CPU bus 216. The I/F 204 receives the printing instruction including the image data for the image forming device 1 from the external computer. The drum driving control circuit 205 drives and controls the driving motor 212 under the control of the CPU 201. The driving motor 212 drives the drum 103. In the embodiment, the CPU 201 controls the rotation of the drum 103 during printing operation.

The charging roller driving control circuit 206 controls the charging roller 104 under the control of the CPU 201. In the embodiment, the CPU 201 controls the charging roller 104 so as to come into contact with or be separated from the surface of the drum 103. The separation distance between the charging roller 104 and the surface of the drum 103 may be a distance in which the charging roller 104 does not come into contact with the paper attracted onto the drum 103. Furthermore, when the charging roller 104 is in contact with the surface of the drum 103, the CPU 201 controls the charging roller 104 so that the charging roller 104 applies a high voltage of about 1 to 3 kV to the paper and the surface of the drum 103. The ink jet head driving control circuit 207 controls the ink jet head 107 under the control of the CPU 201. In the embodiment, the CPU 201 moves the position of the ink jet head 106 in the main scanning direction. Furthermore, the CPU 201 controls the discharging of ink from the ink jet head 107 so as to be synchronized with the transport operation of the paper by the drum 103 based on the printing instruction.

The cleaner driving control circuit 208 drives and controls the driving motors 213 and 214 under the control of the CPU 201. The driving motor 213 drives the roller 1092. The driving motor 214 drives the roller 1094. In the embodiment, the CPU 201 controls the third roller 1094 so as to come into contact with the surface of the drum 103 and so as to be separated from the surface of the drum 103 with the web 1091 interposed. The web 1091 is separated from the drum 103 to follow the separation of the third roller 1094 from the drum 103. The separation distance between the third roller 1094 and the surface of the drum 103 may be a distance at which the web 1091 does not come into contact with the paper attracted onto the drum 103. Furthermore, the CPU 201 performs the control so that the cleaning of the drum 103 by the cleaner 109 is finished, the web 1091 is separated from the drum 103, and then the first roller 1092 is rotated to wind up the web 1091. Specifically, the CPU 201 performs the control so that the web 1091 is wound around the first roller 1092 by an amount (the length in the longitudinal direction) that is in contact with the drum 103. The second roller 1093 is rotated to follow the winding of the web 1091 by the first roller 1092. Thus, the web 1091 wound around the second roller 1093 is released by the winding of the first roller 1092. The portion coming into contact with the drum 103 in the web 1091 is always in a clean state.

The peeling claw driving control circuit 209 drives and controls the solenoid 215 under the control by the CPU 201. The solenoid 215 drives the peeling claw 108. In the embodiment, the CPU 201 performs the control so that the tip of the peeling claw 108 comes into contact with the surface of the drum 103 or is separated from the surface of the drum 103. The separation distance between the tip of the peeling claw 108 and the surface of the drum 103 may be a distance at which the tip of the peeling claw 108 does not come into contact with the paper attracted onto the drum 103.

The transport motor driving control circuit 210 drives and controls a plurality of transport motors under the control of the CPU 201. The plurality of transport motors independently drives the pickup roller 1011, the transport roller pair 1021, the transport roller pair 1022, and the transport roller pair 1101 so as to supply, transport and discharge the paper during printing operation. The sensor circuit 211 controls the first sensor 105 and the second sensor 106 under the control of the CPU 201.

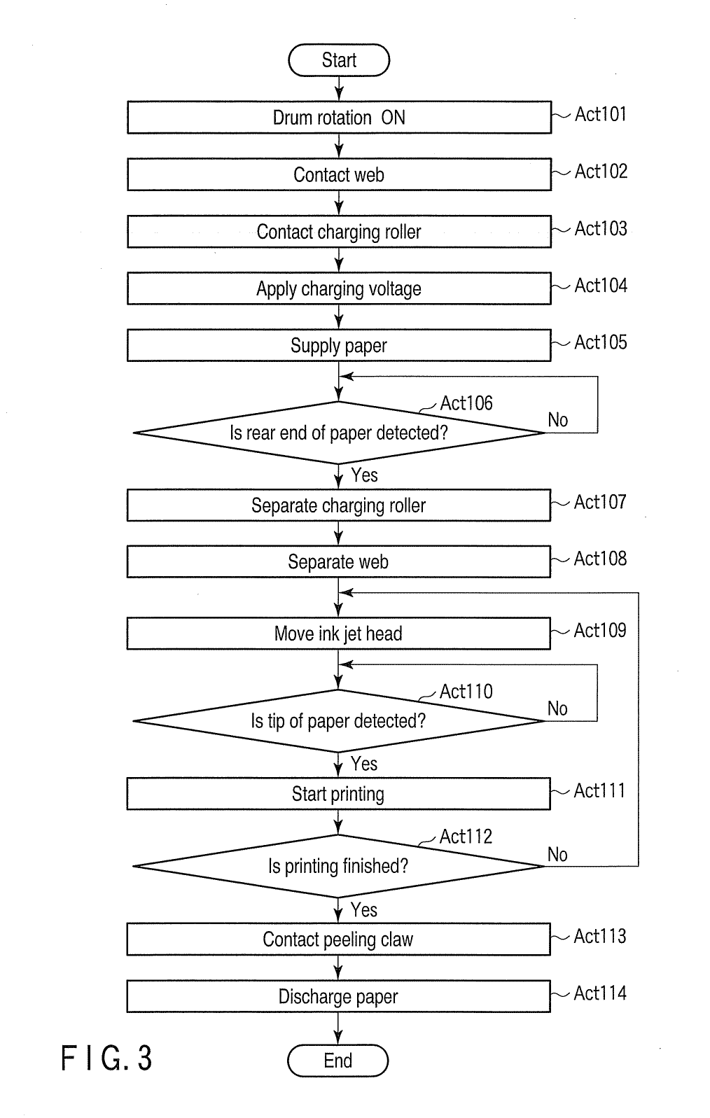

Next, the printing processing in the image forming apparatus will be described. FIG. 3 is a flow chart that shows the printing processing. Herein, the printing processing of a sheet of paper will be described. Before starting the printing processing, the charging roller 104, the third roller 1094, and the tip of the peeling claw 108 are separated from the surface of the drum 103.

The CPU 201 starts the rotation of the drum 103 upon receiving the printing instruction via the I/F 204 (Act 101). The CPU 201 moves the third roller 1094 so that the web 1091 comes into contact with the drum 103 (Act 102). The web 1091 cleans the surface of the rotating drum 103 by coming into contact with the surface of the drum 103. In addition, the web 1091 is extended so as not to move by the first roller 1092, the second roller 1093, and the third roller 1094, and thus, the web 1091 does not move to follow the rotation of the drum 103. Next, the CPU 201 moves the charging roller 104 so as to come into contact with the drum 103 (Act 103). The CPU 201 applies the charging voltage to the charging roller 104 (Act 104). In Act 104, the CPU 201 applies the charging voltage of about 1 to 3 kV to the charging roller 104.

The CPU 201 supplies the paper to the drum 103 (Act 105). In Act 105, the CPU 201 supplies the paper to the drum 103 using the pickup roller 1011, the transport roller pair 1021, and the transport roller pair 1022. The paper is charged by being interposed between the drum 103 and the charging roller 104. Thus, the paper is attracted onto the drum 103. The drum 103 transports the attracted paper by the rotation.

The CPU 201 decides whether or not the first sensor 105 detects the rear end of the paper (Act 106). In Act 106, the CPU 201 decides whether or not the paper is present in a detection region (the surface of the drum 103 facing the first sensor 105) of the first sensor 105 based on the detection information of the first sensor 105. The first sensor 105 detects the change of state from the paper presence to the paper absence, whereby the CPU 201 decides that the paper leaves the position facing the charging roller 104.

Until the first sensor 105 decides that the rear end of the paper leaves, that is, when the first sensor 105 decides that the rear end of the paper is not detected (Act 106, No), the CPU 201 performs the operation of Act 106. When the first sensor 105 decides that the passage of the rear end of the paper is detected (Act 106, Yes), the CPU 201 moves the charging roller 104 so as to be separated from the drum 103 (Act 107). The CPU 201 moves the roller 1094 so that the web 1091 is separated from the drum 103 (Act 108).

The CPU 201 moves the ink jet head 107 to a predetermined position of the main scanning direction depending on the printing instruction (Act 109). The CPU 201 decides whether or not the second sensor 106 detects the tip of the paper (Act 110). In Act 110, the CPU 201 decides that the tip of the paper is in front of the position facing the ink jet head 107 based on the detection information of the second sensor 106.

Until the second sensor 106 detects the tip of the paper, that is, it is decided that the tip of the paper is not detected (Act 110, No), the CPU 201 performs the operation of Act 110. When it is decided that the second sensor 106 detects the tip of the paper (Act 110, Yes), the CPU 201 discharges ink from the ink jet head 107 based on the printing instruction to start the printing on the paper (Act 111). The CPU 201 decides whether or not the printing to the paper attracted onto the drum 103 is finished (Act 112). In Act 112, when printing an image at a resolution equal to or less than the nozzle pitch of the ink jet head 107 based on the printing instruction, the CPU 201 decides that the printing is performed by the ink jet head 107 using one pass. When printing an image at a resolution higher than the nozzle pitch of the ink jet head 107 based on the printing instruction, the CPU 201 decides that the printing is performed by the ink jet head 107 so as to be divided into a plurality of passes.

When deciding that the printing is not finished (Act 112, No), the CPU 201 returns to Act 109, and is moved to the main scanning direction at a pitch depending on the resolution based on the printing instruction. That is, the CPU 201 prints the paper, which is again transported to a position facing the ink jet head 107 by the rotation of the drum 103, using the ink jet head 107. When deciding that the printing is finished (Act 112, Yes), the CPU 201 moves the peeling claw 108 so as to come into contact with the drum 103 (Act 113). The paper attracted onto the drum 103 reaches the position of the peeling claw 108 by the rotation of the drum 103, and is peeled off from the drum 103 from the tip to the rear end by the peeling claw 108. The CPU 201 discharges the paper peeled off from the drum 103 by the peeling claw 108 to the paper discharging tray 111, using the transport roller pair 1101 (Act 114).

In addition, the CPU 201 controls the operation of Act 108 after Act 107, but the CPU 201 may concurrently control Act 107 and Act 108, and may control the operation of Act 107 after Act 108. In addition, if the CPU 201 performs Act 108 before the paper reaches the position facing the third roller 1094, the timing is not limited.

In the embodiment, although the CPU 201 brings the web 1091 into contact with the surface of the drum 103 by moving the third roller 1094, the CPU 201 may bring the web 1091 into contact with the surface of the drum 103 by moving the entire cleaner 109. In the embodiment, although in the cleaner 109, the web 1091 is extended by the first roller 1092, the second roller 1093, and the third roller 1094, the web 1091 may be extended by only the first roller 1092 and the second roller 1093. In the case, the CPU 201 may move the entire cleaner 109 to bring the vicinity of the center in the longitudinal direction of the web 1091, which is provided with tension by the first roller 1092 and the second roller 1093, into contact with the surface of the drum 103.

According to the embodiment, even if ink is attached to the surface of the drum 103, the web 1091 can clean the surface of the drum 103 without damage before the starting of the printing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a support table that rotates around an axis;
a printing head that faces the support table; and
a cleaner that includes a web coming into contact with the support table.

2. The apparatus of claim 1, wherein
the printing head is an ink jet head.

3. The apparatus of claim 2, further comprising:
a controller configured to bring the web into contact with the support table or separate the web from the support table.

4. The apparatus of claim 3, wherein
the controller rotates the support table during printing.

5. The apparatus of claim 4, wherein
the controller brings the web into contact with the support table if the support table is rotated.

6. The apparatus of claim 5, wherein
the web is a nonwoven fabric.

7. The apparatus of claim 1, wherein
the cleaner includes
a first roller that supports the web;
a second roller that supports the web; and
a third roller that faces the support table with the web interposed.

8. The apparatus of claim 7, wherein
the controller brings the third roller into contact with the support table or separates the third roller from the support table.

9. The apparatus of claim 8, wherein
the controller separates the third roller from the support table before a paper is transported to a position facing the web.

10. The apparatus of claim 9, wherein
the controller winds the web around the first roller from the second roller by a predetermined amount after separating the web from the support table.

11. The apparatus of claim 3, further comprising:
a peeling claw that peels off a paper attracted to the support table.

12. The apparatus of claim 3, wherein
the controller controls a paper so as to be transported to a position where a charging roller charging the paper faces the support table.

13. The apparatus of claim 3, wherein
the support table is a drum.

14. The apparatus of claim 3, wherein
the controller moves the printing head in a main scanning direction depending on resolution of an image to be printed on a paper, and prints the paper by the printing head several times.

15. A cleaning method comprising:
rotating a support table around an axis;
brings a web into contact with the support table;
attracting a paper to the support table; and
performing printing based on a print instruction.

16. The method of claim 15, comprising:
receiving the print instruction; and
printing the paper using an ink jet mode.

17. The method of claim 16, wherein
the web is a nonwoven fabric.

18. The method of claim 15, comprising:
separating the web from the support table before the paper is transported to a position facing the web.

19. The method of claim 18, comprising:
bringing a third roller into contact with the support table or separating the third roller from the support table with the web interposed that is supported by a first roller and a second roller.

20. The method of claim 19, comprising:
winding the web around the first roller from the second roller by a predetermined amount after separating the third roller from the support table.
